(19) United States
(12) Patent Application Publication
(10) Pub. No.: US 2014/0012889 A1
(43) Pub. Date: Jan. 9, 2014

(54) Construction Methods for Finite Fields with Split-optimal Multipliers

(71) Applicant: Lisa Fredrickson, Pasadena, CA (US)

(72) Inventor: Lisa Fredrickson, Pasadena, CA (US)

(21) Appl. No.: 13/541,739

(22) Filed: Jul. 4, 2012

(51) Int. Cl. G06F 7/44

(52) U.S. Cl. 708/492

(57) ABSTRACT

Improved multiplier construction methods facilitate efficient multiplication in finite fields. Implementations include digital logic circuits and user scaleable software. Lower logical circuit complexity is achieved by improved resource sharing with subfield multipliers. Split-optimal multipliers meet a lower bound measuring complexity. Multiplier construction methods are applied repeatedly to build efficient multipliers for large finite fields from small subfield components.

An improved finite field construction method constructs arbitrarily large finite fields using search results from a small starting field, building successively larger fields from the bottom up, without the need for successively larger searches. The improved method constructs arbitrarily large finite fields with limited construction effort using a polynomial constant equal to the product of a deterministic product term and a selectable small field scalar. The polynomials used in the improved method feature sparse constants facilitating low complexity multiplication.

### FIELD OF THE INVENTION

The invention relates generally to error correction and encryption coding of data in digital communications using finite fields, and particularly to a method and apparatus for efficient multiplication in finite fields and a method for construction of arbitrarily large finite fields.

### BACKGROUND OF THE INVENTION

A multiplier for complex numbers may be implemented by combining the outputs of smaller multipliers operating over the subfield of real numbers. A complex number, A, may be represented as a two-component vector {a₁, a₀} in a hypothetical computer, with the understanding that complex A may be regarded as a polynomial over the real numbers,

A(j)=a₁j+a₀=Im[A]j+Re[A]

where a₀ and a₁ are real. Recall that the complex product C=AB is given by

C(j)=c₁j+c₀={a₁b₀+a₀b₁}j+{a₀b₀−a₁b₁}.

The relationship may be expressed as

C(j)=A(j) B(j)modulop(j),

where p(x) is an irreducible polynomial of degree two over the real numbers,

p(x)=x²+1,

and j is assumed to be a root of p(x).

A first method of determining the complex product determines four real products {a₁b₀, a₀b₁, a₀b₀, and a₁b₁} and combines the products using a real addition and a real subtraction. In the hypothetical computer, m binary bits represent a real number, and the space-time complexity of a real m-bit multiplier is approximately m², whereas the complexity of real addition, km, is relatively small. The space-time complexity of the complex 2m-bit multiplier by this first method is approximately 4 m² for larger in.

Methods of determining a complex product using only three real multiplications have been known since the 1950s. A discussion is in Fast Algorithms for Digital Signal Processing, Richard E. Blahut, pp. 1-19, ISBN 0-201-10155-6, Addison-Wesley, Reading Mass. (1985). A second method of determining the complex product computes two real additions, three real multiplications, and two real subtractions, s₀=a₁+a₀, s₁=b₁+b₀, m₁=s₀ s₁,m₂=a₁ b₁, m₃=a₀b₀, c₀=m₃ m₂, and c₁=m₁ c₀. The space-time complexity using this second method is approximately 3 m² for larger in.

A similar algorithm may be used to reduce the complexity of multipliers for finite fields, which are also known as Galois fields, in honor of the mathematician Evariste Galois. Early references include Sur la theorie des nombres, Bull Sci. Math. de M. Ferussac 13, 428-435 (1830), J. Math. Pures Appl. 11, 398-407 (1846), and Oeuvres math., pp. 15-23, Gauthier-Villars, Paris, 1987.

A field with q elements is denoted GF(q); the smallest finite field is the field GF(2). The finite fields constructed here are extension fields of GF(2) with m-bit symbols, denoted GF(2^{m}). These fields are known as fields of characteristic two, defined as a field where A+A=0 for any field symbol A. In these fields, addition is the same as subtraction.

It turns out that a minimal complexity multiplier for a finite field with a small number of bits per symbol, i.e. in <6, typically uses a standard field representation, sometimes referred to in the literature as an “alpha-basis” or “canonical” representation. In a canonical representation for GF(2^{m}), a symbol B is represented by in bits, denoted b₀ to bₘ₋₁ here, and a distinguished element alpha (α) is defined with the understanding that

B=b₀+b₁α+b₂α²+ . . . +bₘ₋₁α^{m-1}.

A small canonical multiplier for m-bit symbols requires (4m²−3) gate-area units as counted here. For example, a one-bit multiplier for GF(2) is implemented as a logical AND gate, whose complexity is counted as one gate-area unit here. A one-bit adder for GF(2) is assumed to have greater complexity; it is implemented as a logical exclusive-or (XOR) gate,

a+b=aXORb=(aANDb)NOR(aNORb),

and counted as three gate-area equivalent units here. Prior art implementations for subfields with m=2, 3, 4 or 5 are detailed further below and their complexity is summarized in Table 1.

TABLE 1
Minimal complexity canonical multipliers for small fields

| m | Finite Field | AND gates | XOR gates | Gate-area units |
|---|---|---|---|---|
| 1 | GF(2) | 1 | 0 | 1 |
| 2 | GF(4) | 4 | 3 | 13 |
| 3 | GF(8) | 9 | 8 | 33 |
| 4 | GF(16) | 16 | 15 | 61 |
| 5 | GF(32) | 25 | 24 | 97 |

A non-standard “split-field” multiplier may become a less complex alternative when the number of bits per symbol is even and at least six. A lower bound on the complexity of split-field multipliers is the combined complexity of three subfield multipliers and four subfield adders. If six bit symbols for GF(64) are split into two three-bit symbols over the subfield GF(8), for example, the lower bound using three GF(8) multipliers and four GF(8) adders is 135 gate-area units. A canonical multiplier for GF(64) is larger, using 141 gate-area units. In order to achieve the potential savings, an improved split-field multiplier whose complexity meets the lower bound is desired.

A prior art split-field multiplier is used to develop the lower bound and compared with an improved multiplier below. The prior art multiplier is shown as FIG. 8c in U.S. Pat. No. 4,958,348, Hypersystolic Reed-Solomon Decoder, Berlekamp et al. (1988), and discussed on pp. 4-5 of U.S. Pat. No. 5,689,452, Method and apparatus for performing arithmetic in large Galois field GF(2ⁿ), Cameron (1994). The multiplier uses a split-field representation, where an element (or “symbol”) in a finite field G with 2m-bit symbols has each symbol represented as a polynomial over a subfield F with m-bit symbols. It is known that if a quadratic polynomial

p(x)=p₂x²+p₁x+p₀

is irreducible over the field F, i.e. it has no roots in F, an irreducible polynomial of the form

q(x)=x²+x+β

may be derived from p(x), where β is an element of F. The prior art multiplier uses an irreducible polynomial of the q(x) form. According to the teaching of the '452 patent, the limitation of form is not significant because an arbitrary primitive polynomial of degree two may be converted to the desired form through an algebraic transformation.

Let ω be a root of q(x). Symbols A and B from G are represented as

A(ω)=a₁ω+a₀

B(ω)=b₁ω+b₀

where a₁, a₀, b₁, and b₀ are elements of F. The polynomial product

A(ω)B(ω)=a₁b₁ω²+{a₁b₀+a₀b₁}ω+a₀b₀

is reduced modulo q(ω) to a polynomial of degree one or less. Because ω is a root of q(x), ω²+ω+β=0, and it follows that C(ω)=c₁ω+c₀, where

c₁=a₁b₀+a₀b₁+a₁b₁, and

c₀=a₀b₀+βa₁b₁.

The desired product may be determined as follows:

t₀=a₁+a₀,

t₁=b₁+b₀,

m₁=t₀t₁,

m₂=a₁b₁,

m₃=a₀b₀,

c₀=m₃+βm₂, and

c₁=m₁+m₃.

The multiplier for the field G using this prior art method has the complexity of three full multipliers and four adders for the field F plus the additional complexity, if any, of the constant multiplier used to multiply by β.

Field construction is discussed in “A New Architecture for a Parallel Finite Field Multiplier with Low Complexity Based on Composite Fields,” C. Paar, IEEE Trans. Computers, pp. 856-861, Vol. 45, No. 7, July 1996. Paar attributes the prior art method discussed above to V. Afanasyev, “On the Complexity of Finite Field Arithmetic,” Proc. Fifth Joint Soviet-Swedish Int'l. Workshop Information Theory, pp. 9-12, Moscow, USSR, January 1991.

The prior art method may be applied repeatedly to produce large finite fields as discussed further below. As a simple example, consider an m-bit symbol field F which has been extended to a 2m-bit symbol field G using a first irreducible polynomial q(x) of degree two over F. A second, 4m-bit symbol extension field H is to be constructed using a second application of the method. Paar teaches that the field G is exhaustively searched to determine those primitive polynomials q(x) with a minimum complexity with respect to constant multiplication by β (see p. 859).

Repeated application of the prior art method requires an ability to repeatedly search and identify a next member in a sequence of successive irreducible quadratic polynomials over larger and larger fields. To select the next sequence member, Paar further requires that all primitive polynomials in the set of possible irreducible quadratic polynomials be identified and that these polynomials are sorted for minimum multiplier complexity. He does not teach or suggest a method of repeatedly constructing extension fields without a plurality of searches for suitable polynomials. The search process becomes exponentially time consuming for large finite fields, limiting the size of finite fields which can be practically constructed using this prior art method. Instead, a general method to provide a sequence of extension polynomials facilitating minimal complexity multiplication without repeated searching is desired.

### BRIEF SUMMARY OF THE INVENTION

The invention incorporates an improved method of representing a finite field as an extension field, facilitating minimally complex multipliers for GF(2^{2m}). The improved methods are implemented in improved integrated circuits with low gate-area and are suitable for efficient implementations in software on a general-purpose computer. A “spit-optimal” multiplier meets a lower bound on the gate-area complexity, constructed with the gate area of three full subfield multipliers and four subfield adders, and no additional gates. An improved method and apparatus for multiplying provide improved support for split-optimal multipliers and efficient multiplication. The method of multiplication facilitates efficient multiplicative inversion.

A related method of repeatedly extending a small finite field to construct an arbitrarily large finite field is also disclosed. Split-optimal and nearly split-optimal solutions are disclosed for a wide variety of finite fields, in the range of four to 512 bits per symbol. The improved method facilitates construction of minimally complex multipliers for large finite fields by explicitly providing improved resource sharing to implement constant multipliers, and by utilizing particular polynomials with almost all-zero constants. The use of these constants facilitates efficient software implementations. Other desirable properties are incorporated in the constructed finite fields.

### BRIEF DESCRIPTION OF THE SEVERAL VIEWS OF THE DRAWING

FIG. 1 is an example schematic of hierarchical circuitry to multiply in an extension field, divided into three example levels of hierarchy.

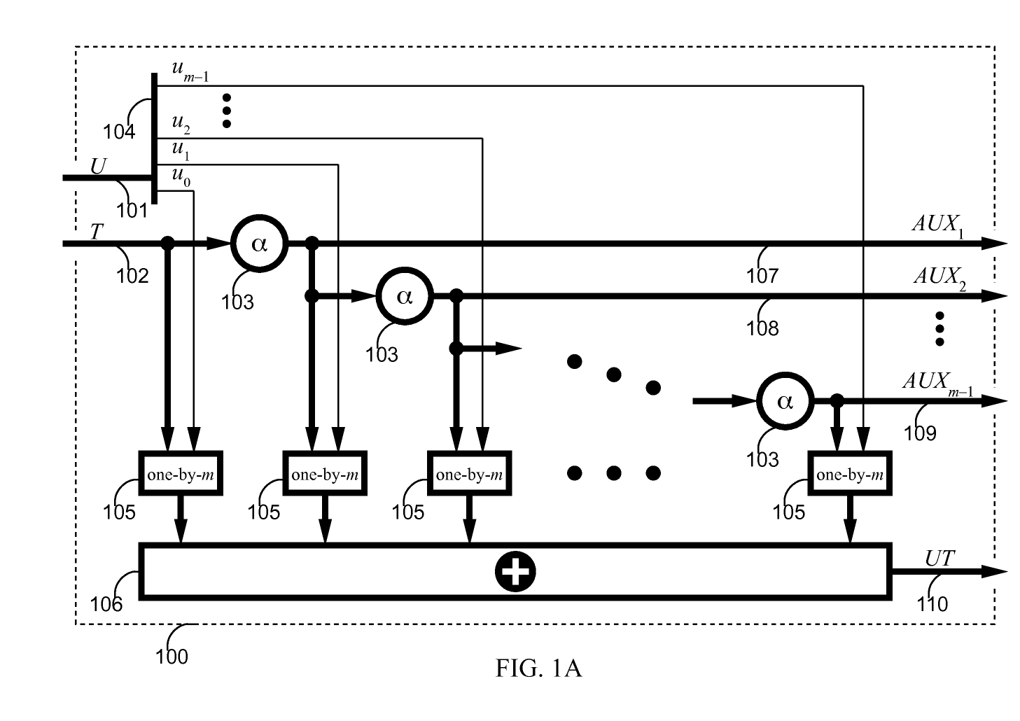

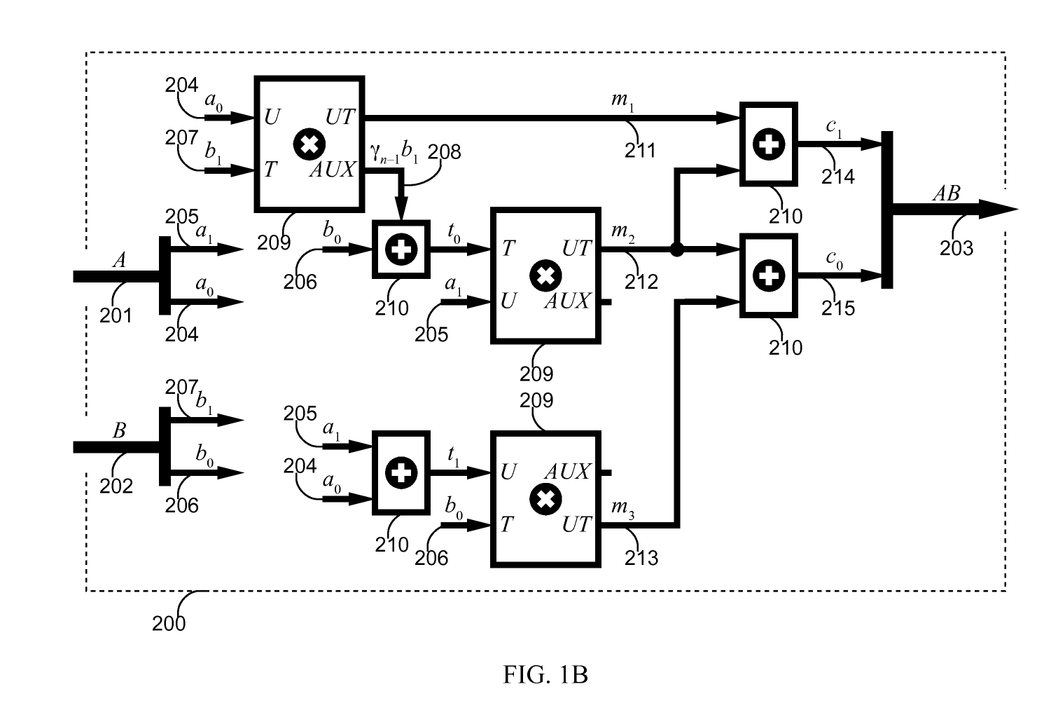

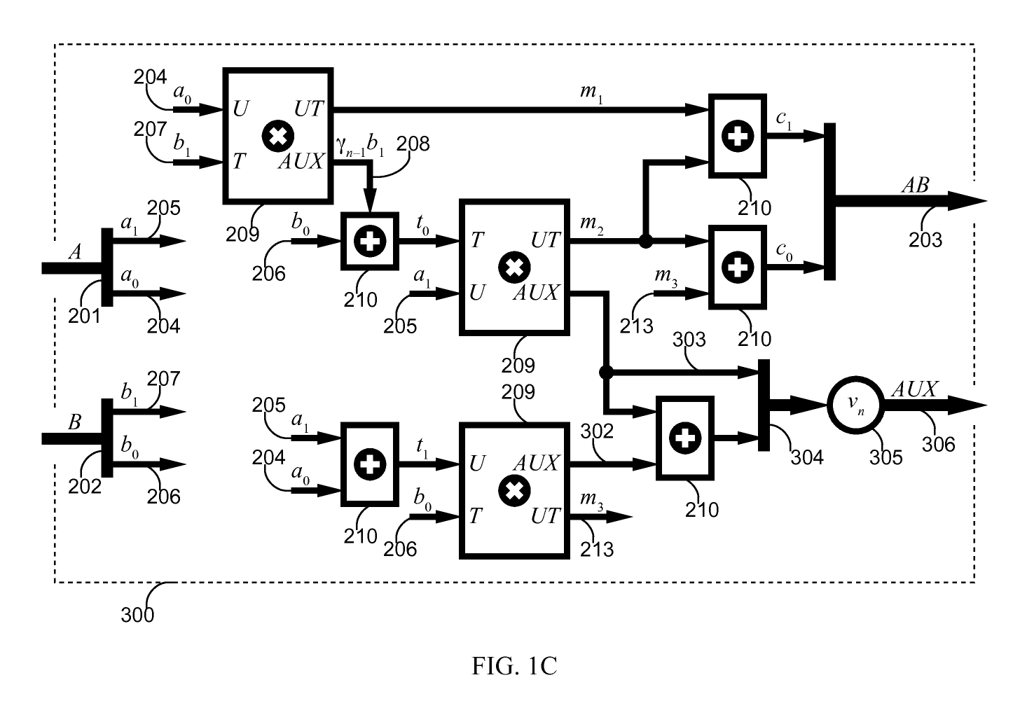

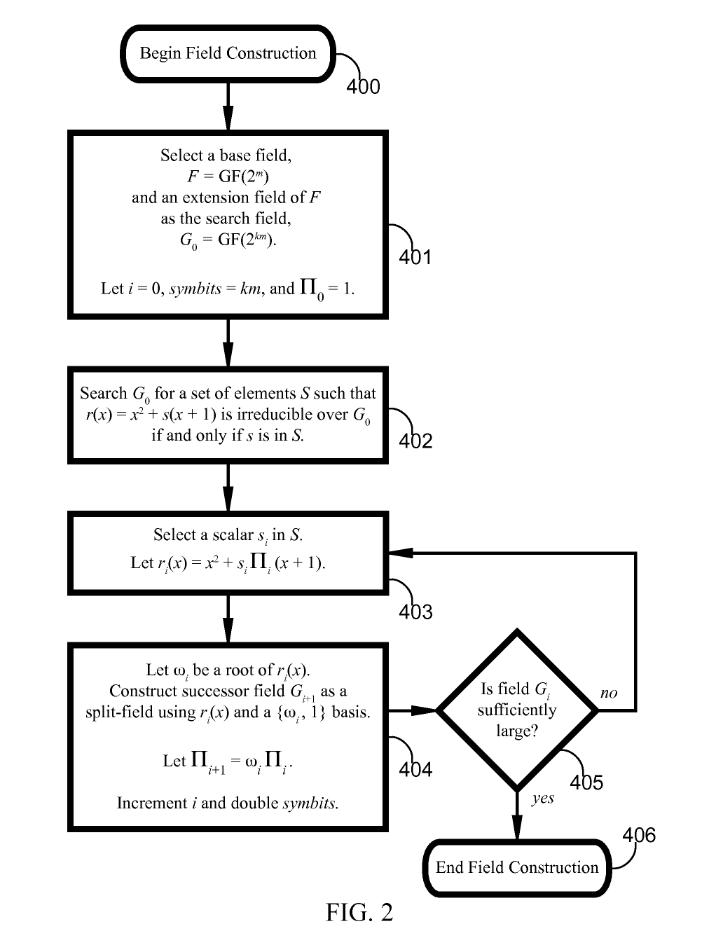

An example first (or bottom) level of hierarchy for a finite field multiplier is shown in FIG. 1A. The circuit contains modifications to a canonical subfield multiplier that add one or more auxiliary outputs to explicitly provide resource sharing for a successive level of hierarchy.

An example last (or top) level of hierarchy for a finite field multiplier is shown in FIG. 1B. The multiplier circuit for an extension field includes three subfield multipliers and four subfield adders. An auxiliary output of a subfield multiplier provides a constant multiplication.

An example middle level of hierarchy for a finite field multiplier containing three or more levels of hierarchy is shown in FIG. 1C. An auxiliary output is added to the circuitry of FIG. 1B to explicitly provide resource sharing for a successive level of hierarchy.

FIG. 2 is a flowchart representing a method of constructing arbitrarily large finite fields.

### DETAILED DESCRIPTION OF THE INVENTION

A.1. Improved Split-Field Multiplication

Assume that finite field G has a split-field representation where each 2m-bit symbol is represented as a polynomial over a subfield F with m-bit symbols. In the field F, select an irreducible polynomial of the form

r(x)=x²+γx+y=x²+γ(x+1)

where γ is an element of F. Preferably, the polynomial r(x) is selected so that the coefficient γ facilitates low complexity constant multiplication, as shown further below.

Let ω be a root of r(x). Symbols A and B from G are represented as

A(ω)=a₁ω+a₀

B(ω)=b₁ω+b₀

where a₁, a₀, b₁, and b₀ are elements of F. The polynomial product

A(ω) B(ω)=a₁b₁ω²+{a₁b₀+a₀b₁}ω+a₀b₀.

is reduced modulo r(ω) to obtain C(ω)=C₁ω+c₀, where

c₁=a₁b₀+a₀b₁+γa₁b₁, and

c₀=a₀b₀+γa₁b₁.

The desired product may be determined as follows:

m₁=a₀b₁,

t₀=γb₁+b₀,

t₁=a₁+a₀,

m₂=a₁t₀

m₃=b₀t₁

c₀=m₃+m₂, and

c₁=m₁+m₂.

These equations incorporate the complexity of three full subfield multipliers and four subfield adders plus the additional complexity, if any, of a constant multiplier for γ. All operations are performed over the subfield F.

FIG. 1B is a schematic of a multiplier circuit 200 for G to implement these equations without additional complexity for the constant multiplier. The circuit 200 multiplies a first input symbol A 201 by a second input symbol B 202 to produce a product symbol AB 203. Symbols A, B and AB are elements of G, each symbol represented by 2m bits. The circuit 200 contains three m-bit subfield multipliers for the field F, a first multiplier 209 with output m₁ 211, a second multiplier 209 with output m₂ 212, and a third multiplier 209 with output m₃ 213. Circuit 200 also contains four adders 210 for the field F. A first adder 210 outputs t₀ and a second adder 210 outputs t₁. The remaining two adders 210 output the two components of the product, c₀ 215 and c₁ 214, which are combined in the 2m-bit output symbol AB 203.

In FIG. 1B, the input symbol A 201 is partitioned into two m-bit symbols from F, a₀ 204 and a₁ 205. Similarly, input symbol B 202 is partitioned into b₀ 206 and b₁ 207 from F. Various circuit interconnections within FIG. 1B are not shown to improve clarity; they are indicated by labeling of signal sources and sinks Symbol a₀ 204, for example, is sourced at the partitioning of bus 201 and connected to sinks at the U input of the first multiplier 209 and the second input of the second adder 210. Similarly, a₁ 205 is connected to the U input of the second multiplier 209 and the first input of the second adder 210.

Note that the first subfield multiplier 209 has an input operand, b₁ 207, and a first subfield adder 210 has the same input operand b₁ 207, but scaled by γₙ₋₁ in signal 208. Often, an auxiliary output 208 of the first subfield multiplier can be used as a source for the scaled operand with negligible additional cost, as demonstrated in the following sections.

A.2. Resource Sharing with a Canonical Subfield

Lets first consider a finite field G in a split-field representation where the subfield F is an m-bit subfield in a canonical representation, with m=2, 3, 4, or 5. Each symbol A in the field F is represented by m binary coefficients {aₘ₋₁, . . . , a₁, a₀} and associated with a polynomial

A(α)=a₀+a₁α+ . . . +aₘ₋₁α^{m-1},

where α is a root of p(x), an irreducible polynomial of degree m over GF(2). Lists of suitable binary irreducible polynomials may be found in W. Wesley Peterson and E. J. Weldon, Jr., Error-Correcting Codes, Second Edition, Appendix C, pp. 472-492, ISBN 0-262-16-039-0, The MIT Press, Cambridge, Mass. (1980).

Preferably, the polynomial p(x) has a minimum number of nonzero coefficients, resulting in simpler reduction modulo p(x). Preferred trinomials of the form

p(x)=x^{m}+x+1

are irreducible over GF(2) and result in minimal complexity multipliers with minimal delay for the field F when m=2, 3, or 4. When m=5, a preferred trinomial, p(x)=x⁵+x³+1, may be used instead.

In some applications, it is preferred that the polynomial p(x) is a primitive polynomial, defined as follows. Let polynomial p(x) be an irreducible over a field F, and let ω be a root of p(x). The polynomial is used to generate a field G, each element of G representing an equivalence class of polynomials modulo p(ω) over F. Suppose that G has N distinct symbols. The polynomial p(x) is considered primitive over F if the powers of ω modulo p(ω), i.e. ω¹ modulo p(ω), ω² modulo p(ω), ω³ modulo p(ω), and so on, are the N−1 distinct nonzero elements of the field G. In this case, the polynomial root, w, is known as a primitive element of the field G and can be used as a base for logarithm and antilog tables. Each of the example polynomials above, for m in the range of two to five, is primitive over the field GF(2).

A minimal complexity subfield multiplier for a canonical subfield F is modified to be suitable for the purposes here in building larger fields. An example modified subfield multiplier 100 is shown in FIG. 1A. If U and T are symbols of F with the understanding that a symbol such as U is regarded as a polynomial,

U(α)=u₀+αu₁+ . . . +α^{m-1}uₘ₋₁,

then it follows that the product of U and T,

U(α)T(α)modulop(α)=u₀T(α)

+u₁{αT(α)modulop(α)}

+ . . .

+uₘ₋₁{α^{m-1}T(α)modulop(α)}.

The coefficients of the term [α^{k} T(α) modulo p(α)] may be determined from the coefficients of the previous term, [α^{k-1} T(α) modulo p(α)], by multiplying by α and reducing modulo p(α). For example, if the binary m-tuple

{vₘ₋₁, . . . ,v₁,v₀}

represents an element V of F with m=2, 3, or 4, the element {αV modulo p(α)} is represented by

{vₘ₋₂, . . . ,v₁,vₘ₋₁+v₀,vₘ₋₁}

The scaled element can be implemented using one XOR gate and a rearrangement of bits. Each circled “α” represents an α-multiplier 103 in FIG. 1A and implements a multiplication by α and reduction modulo p(α) as described. A first α-multiplier 103 scales input T 102 by a to output a first auxiliary output symbol AUX₁ 107. When m>2, a second α-multiplier 103 outputs a second auxiliary output symbol AUX₂ 108. When m is three or greater, the sequence of α-multipliers continues until the (m−1)^{th} α-multiplier 103 outputs an (m−1)^{th} auxiliary output symbol AUXₘ₋₁ 109.

Each sub-product symbol, {uₖα^{k}T(α) modulo p(α)}, can then be implemented as a one-by-m product using m parallel AND gates with a common input uₖ and an m-bit input {α^{k}T(α) modulo p(α)}. In FIG. 1A, input U 101 feeds bus separator 104, providing the individual bits of U to produce a plurality of one-by-m sub-products in sub-circuits labeled “one-by-m” 105. Finally, the various sub-products are summed using an array of XOR gates 106 to output the product UT 110.

For example, FIG. 1A illustrates a best prior art multiplier for GF(16) constructed using p(x)=x⁴+x+1, a primitive polynomial over GF(2). The two inputs to the subfield multiplier, U and T, are 4-bit symbols, depicted as thicker m-bit wide busses in FIG. 1A. Three XOR gates and bit rearrangements provide a chain of three multiplications by α as described above. Sixteen AND gates implement four one-by-four multiplications, and twelve XOR gates are used to produce the sum of the four sub-products.

When a canonical multiplier is used as a subfield multiplier in a larger field multiplier, the subfield multiplier is explicitly modified to support resource sharing in the larger multiplier by providing useful auxiliary outputs, such as those shown in FIG. 1A. Preferably, scaling of one subfield multiplier input by γ is provided as an auxiliary output of a subfield multiplier. The modified subfield multiplier of FIG. 1A, explicitly outputting the scaling of input T 102 by a plurality of low powers of α, provides one or more useful auxiliary outputs for those purposes here. When used as a subfield multiplier for GF(16), for example, it provides three possible constant multiplications in auxiliary outputs, AUX₁ 107, AUX₂ 108, and AUX₃ 109, at no additional gate-area cost.

In various examples below, one or more auxiliary outputs may be left unused, or there may be additional auxiliary outputs referred to but not shown in FIG. 1A, where the number of auxiliary outputs is m−1. For example, consider a GF(4) subfield multiplier with two-bit wide inputs, U 101 and T 102. The two-bit input vector T may be denoted {t₁, t₀}. One scaled input,

αT(α)modulop(α),

—the vector {t₁+t₀, t₁}—is an internally available scaled input that can be explicitly provided as a first auxiliary output, AUX₁={t₁+t₀, t₁}. In addition, another low α-power scaling of the input T,

α²T=α²T(α)modulop(α)=t₀α+(t₁+t₀),

can be provided as a second auxiliary output, AUX₂={t₀, t₁+t₀}, at negligible gate-area cost by reusing the output of the (t₁+t₀) XOR gate and arranging output bits accordingly.

To continue with this example, suppose that a GF(16) multiplier is then constructed using the split-field representation over GF(4). An irreducible polynomial r(x) over GF(4) of the form

r(x)=x²+γx+γ

is chosen to generate G as an extension field of F, preferably with multiplication by γ facilitated by one or more auxiliary outputs of the subfield multiplier. Here, the selection of a polynomial r(x) with either {γ₀=α} or {γ₀=α²} provides a primitive polynomial for constructing G. By using a modified canonical subfield multiplier for GF(4) 100 with two corresponding auxiliary outputs as multiplier 209 in FIG. 1B, the constant multiplication for either polynomial can be provided at no additional cost in multiplier 200, providing a split-optimal multiplier for GF(16). In this case, FIG. 1B represents a GF(16) multiplier where the internal components of the multiplier operate over GF(4).

Note that, as a first approximation of complexity, only additional gates are counted here. Additional complexity costs of buffering signals, of providing additional outputs, and of routing additional signals are mostly ignored here.

This example split-optimal multiplier is considered the best design here for a split-field representation of GF(16), meeting the lower bound by using only three GF(4) multipliers and four GF(4) adders to implement the GF(16) multiplier. The complexity of the improved split-field design is 63 gate-area units.

As a final complexity check, the best split-field design for GF(16) is compared to other multipliers for GF(16), such as a smaller canonical GF(16) multiplier using 61 gate-area units. When the gate area is equal or nearly equal, other issues may arise. In some applications, implementations using only primitive polynomials may be preferred or required. A circuit for a low complexity multiplicative inverter may be required as well. The suitability of the multiplier for G as a building block in a split-field multiplier for a larger field in a hierarchical design may also be considered. The hierarchical approach is explored further in the following section, and inversion is in the section after that.

A.3. Resource Sharing with a Split-Field Subfield

In the previous section, a first extension field G is constructed as a split-field representation over a canonical field F. In this section, lets denote the first field F as G₀, and the first extension field, G, as G₁. The approach advocated here provides optimal and near-optimal split-field multipliers for fields further extended from G₁, providing a sequence of fields, G₂, G₃, and so on, each with a successive doubling of the field symbol size. In a multi-layer hierarchical design, FIG. 1B may be regarded as an Nth (or last or top) layer for multiplying in a largest successor field G_{N}. In this section, a modified middle layer explicitly supports resource sharing in a hierarchical design with at least three layers.

For example, G₁ may be constructed with a split-field multiplier as in the previous section with 4, 6, 8, or 10 bit symbols, as an extension field of G₀, a canonical subfield F. In this case, a first extension polynomial r₀(x)=x²+γ₀x+γ₀ with root ω₀ is assumed to generate G₁. The G₁ multiplier is modified to explicitly support a G₂ multiplier with 8, 12, 16, or 20 bit symbols. In this case, the G₂ hierarchical design would have three layers.

The 2m-bit split-field multiplier of FIG. 1B for a field G, may be modified to explicitly support a 4m-bit multiplier for a successor split-field Gₙ₊₁. Each symbol A in the field Gₙ is represented by two m-bit coefficients {a₁, a₀} and associated with a polynomial

A(ωₙ₋₁)=a₀+ωₙ₋₁a₁,

where ωₙ₋₁ is a root of rₙ₋₁(x)=x²+γₙ₋₁x+γₙ₋₁, an irreducible polynomial of degree two over a subfield Gₙ₋₁.

A polynomial of the form

rₙ(X)=x²+γₙx+γₙ

is irreducible over Gₙ and is used to generate Gₙ₊₁. Generally, the polynomial rₙ(x) is selected so that the constant multiplication by γₙ is easily implemented.

In preferred embodiments, the constant γₙ has a minimum number of nonzero coefficients. The constant γₙ is an element of Gₙ, with components {f₀,f₁} and associated polynomial representation

γₙ(ωₙ₋₁)=f₀+ωₙ₋₁f₁

where f₀ and f₁ are symbols of Gₙ₋₁. A constant γₙ with f₀=0 is preferably selected, simplifying multiplication. It turns out that a constant of this form is always available for the fields of interest here.

For example, if n=1, a preferred γ₁ is of the form

γ₁(ω₀)=s₁ω₀

where s₁ is a scalar in the field G₀. To explicitly support a G₂ multiplier, the G₁ multiplier is augmented to provide an auxiliary output corresponding to γ₁B,

$$\begin{matrix}{γ}_{1} ( {ω}_{0} ) B ( {ω}_{0} ) = {s}_{1} {ω}_{0} ( {b}_{0} + {ω}_{0} {b}_{1} ) \\ = {s}_{1} \{ {ω}_{0} {b}_{0} + {ω}_{0}^{2} {b}_{1} \} \\ = {s}_{1} \{ {ω}_{0} {b}_{0} + ( {γ}_{0} {ω}_{0} + {γ}_{0} ) {b}_{1} \} \\ = {s}_{1} \{ ( {γ}_{0} {b}_{1} + {b}_{0} ) {ω}_{0} + {γ}_{0} {b}_{1} \} .\end{matrix}$$

If an auxiliary output AUX is given by

AUX(ω₀)=aux₀+ω₀aux₁

then the two components of AUX are

aux₁=s₁(γ₀b₁+b₀), and

aux₀=s₁γ₀b₁.

These components are often available without adding gates to the G₁ multiplier, providing a split-optimal G₂ multiplier. As one example, let G₀ be a canonical representation of the five bit symbol field GF(32), generated by the polynomial

p(x)=x⁵+x³+1,

a primitive polynomial over GF(2). Let α be a root of p(x). Let G₁ be a split-field representation of the 10-bit symbol field GF(1024), generated by the polynomial

r₀(x)=x²+α³x+α³,

a primitive polynomial over GF(32). A split-optimal multiplier for the field GF(1024) is constructed as shown in FIG. 1B using three GF(32) subfield multipliers, the subfield multiplier 209 that outputs m₁ 211 providing a single auxiliary output 208 to scale b₁ 207 by α³. Let ω₀ be a root of r₀(x). A preferred choice for extension to 20-bit symbols is

r₁(x)=x²+γ₁x+γ₁

where s₁=1 and γ₁=s₁ω₀=ω₀. The polynomial

r₁(x)=x²+ω₀x+ω₀

is primitive over the split-field GF(1024) and can be used to generate GF(2²⁰) with a doubly split-optimal multiplier. The first component

aux₀=γ₀b₁

is available at auxiliary output 208 of FIG. 1B. The second component

aux₁=s₁(γ₀b₁+b₀)=γ₀b₁+b₀

is available at the output t₀ of the first adder 210, equal to the sum of auxiliary output 208 and b₀ 206. The two components in this case can be combined in an auxiliary output (not shown in FIG. 1B) without adding any gates to the G₁ multiplier. The middle layer for the G₂ multiplier, as shown in FIG. 1B with five bit G₀ components, is modified to provide the next auxiliary output for the top layer (not shown). The top layer for the G₂ multiplier is also constructed as shown in FIG. 1B, but with 10-bit G₁ components.

Another special case (not shown in FIG. 1B) for augmenting the G₁ multiplier occurs when s₁ is the multiplicative inverse of γ₀. In this special case,

aux₀=s₁γ₀b₁=b₁

is available as signal 206, one component of input B 202. The other component

aux₁=s₁(γ₀b₁+b₀)

may be available as an auxiliary output of the second subfield multiplier 209 of FIG. 1B with output m₂ 212, which provides an auxiliary output equal to the product of a scalar and the T input, t₀=γ₀b₁+b₀, if s₁ is one of the available auxiliary output scaling values.

A third split-optimal case (not shown in FIG. 1B) for G₂ occurs when both S₁ and s₁γ₀ are available scaling values from auxiliary outputs in the subfield multipliers. In this special case, the component aux₀ is typically available as an auxiliary output of the first multiplier 209 with output m₁ 211 while component aux₁ is available as an auxiliary output of the second multiplier 209 with output m₂ 212.

In general, the split-field multiplier for G, provides resources for multiplication by the constant γₙ by supplying one or more auxiliary outputs. An augmented split-field multiplier circuit 300 is shown in FIG. 1C. Most of the components and signals are the same as those shown in FIG. 1B.

In FIG. 1C, each subfield multiplier 209 for the field for Gₙ₋₁ is assumed to provide an auxiliary output providing scaling of the T input by

γₙ₋₁=sₙ₋₁Πₙ₋₁

where sₙ₋₁ is a scalar from G₀, and the product symbol Πᵢ is defined by Π₀=1 and

Πᵢ=ωᵢ₋₁Πᵢ₋₁

for i>0. The multiplier for Gₙ is modified to provide an auxiliary output

$$\begin{matrix}{γ}_{n} B = {γ}_{n} ( {ω}_{n - 1} ) B ( {ω}_{n} - 1 ) \\ = {s}_{n} {\prod }_{n} ( {b}_{0} + {ω}_{n - 1} {b}_{1} ) \\ = {s}_{n} {\prod }_{n - 1} {ω}_{n - 1} ( {b}_{0} + {ω}_{n - 1} {b}_{1} ) \\ = {s}_{n} {\prod }_{n - 1} \{ {ω}_{n - 1} {b}_{0} + {ω}_{n - 1}^{2} {b}_{1} \} \\ = {s}_{n} {\prod }_{n - 1} \{ {ω}_{n - 1} {b}_{0} + ( {γ}_{n - 1} {ω}_{n - 1} + {γ}_{n - 1} ) {b}_{1} \} \\ = {s}_{n} {\prod }_{n - 1} \{ ( {s}_{n - 1} {\prod }_{n - 1} {b}_{1} + {b}_{0} ) {ω}_{n - 1} + {s}_{n - 1} {\prod }_{n - 1} {b}_{1} \} .\end{matrix}$$

In a preferred embodiment, the two components of γₙB,

aux₀=sₙΠₙ₋₁sₙ₋₁Πₙ₋₁b₁ and

aux₁=sₙΠₙ₋₁{(sₙ₋₁Πₙ₋₁b₁+b₀),

are available without adding additional gates to the multiplier for Gₙ, providing an auxiliary output to support a split-optimal multiplier for Gₙ₊₁. Alternatively, one or more auxiliary outputs of the multiplier Gₙ are modified or combined to facilitate easy multiplication by γₙ in the multiplier for Gₙ₊₁.

When the field extension method is applied repeatedly, the potential gate area savings of providing multiple auxiliary outputs may be outweighed by the need to accommodate additional bus area and routing for each additional auxiliary output, and the assumption that additional auxiliary outputs can be added without additional cost becomes less valid.

FIG. 1C depicts an augmented split-field multiplier 300 demonstrating one method of providing a single useful auxiliary output 306, an augmentation not shown in FIG. 1B. The output AUX 306 has been added to provide resource sharing for further levels of hierarchy. In FIG. 1C, it is assumed that all subfield multipliers 209 provide a single auxiliary output scaling by the same constant, γₙ₋₁.

The auxiliary output 303 of multiplier 209 of FIG. 1C provides a scaling of the multiplier's T input,

γₙ₋₁t₀=sₙ₋₁Πₙ₋₁t₀=sₙ₋₁Πₙ₋₁(sₙ₋₁Πₙ₋₁b₁+b₀)=sₙ₋₁aux₁/sₙ.

### Define

vₙ=sₙ/sₙ₋₁.

If vₙ is not one, the component aux₁ can be obtained by re-scaling signal 303 by vₙ in a constant multiplier. Similarly, auxiliary output 302 is a scaling of the T input of the third multiplier 209,

γₙ₋₁b₀=sₙ₋₁Πₙ₋₁b₀.

The sum of auxiliary output 302 and auxiliary output 303 in a fifth adder 210 of FIG. 1C is

sₙ₋₁aux₀/sₙ.

The component aux₀ can be obtained by re-scaling the output of the fifth adder 210 by vₙ in a constant multiplier. The two pre-scaled components of the auxiliary output are combined in bus 304, re-scaled in constant multiplier 305, and output on AUX 306.

As discussed above, a few first layers in a hierarchical design can be split-optimally crafted by appropriately selecting values for γ₁, γ₂, and so on to use available resources, and, if necessary, a plurality of auxiliary outputs may be added to explicitly provide resource sharing for one or more additional layers in a similar manner. However, as the number of hierarchical layers increases and the constructed field grows exponentially, so does the additional bus area for additional auxiliary output. For higher levels of hierarchy, using a relatively small number or extra gates to facilitate a chain of constant multiplications from a single auxiliary output, as in FIG. 1C, may provide a better design tradeoff.

A.4. Matching Inverter for a Split-Field Multiplier

When G is in a split-field representation as described here, a low complexity inverter for the field G is available. Let A be a nonzero symbol in a G with 2m-bit split-field symbols, generated by an irreducible polynomial r(x)=x²+γx+γ over an m-bit subfield F. Let ω be a root of r(x), and let A be such that

A(ω)=a₁ω+a₀.

Let B be the element associated with

B(ω)=a₁ω+(a₀+γa₁)

Note that d=AB is given by

$$\begin{matrix}A ( ω ) B ( ω ) = {a}_{1}^{2} {ω}^{2} + \{ {a}_{1} ( {a}_{0} + γ {a}_{1} ) + {a}_{1} {a}_{0} \} ω + {a}_{0} ( {a}_{0} + γ {a}_{1} ) \\ = {a}_{1}^{2} \{ γ ω + γ \} + γ {a}_{1}^{2} ω + {a}_{0} ( {a}_{0} + γ {a}_{1} ) \\ = {a}_{1}^{2} γ + {a}_{0} ( {a}_{0} + γ {a}_{1} ) .\end{matrix}$$

If A is nonzero, then d is nonzero, and d is a member of the subfield F. Let e be the multiplicative inverse of d in the subfield F,

e=1_{F}/d.

It follows that C=eB is the multiplicative inverse of A in G. The following equations can be used to determine C(ω), the multiplicative inverse of A(ω):

s=a₀+γa₁,

d=a₀s+γa₁²,

e=1/d,

c₀=es,

c₁=ea₁,

where

C(ω)=C₁ω+c₀.

In these equations, all operations are performed over the subfield F. In particular, the formulas express the inverse for field G in terms of the simpler inverse for subfield F. If G is GF(16) implemented as a split-filed over GF(4), for example, nonzero d is an element of GF(4), and d has two binary components {d₁, d₀}. The inverse of d has components

{e₁,e₀}={d₁,d₁+d₀}.

In comparing the inverter for a split-field representation to the inverter for a canonical representation, the equations for a multiplicative inverse for the latter tend to contain a larger number of terms in a large finite field and are not easily simplified.

B.1. Construction of Arbitrarily Large Finite Fields

Consider the problem of constructing multipliers for a fairly large finite field G, such as one with 512 bit symbols. A problem with prior art methods is that the identification of one or more irreducible polynomials needed for construction of very large finite fields may be impractically difficult. For example, a prior art construction method for a field with 512 bit symbols as a canonical representation over GF(2) requires finding an irreducible polynomial of degree 512 over GF(2). Because tabulated polynomials are limited, the field constructor must typically conduct one or more polynomial searches. To check if an arbitrary binary polynomial of degree 512 is irreducible, a searcher determines if the arbitrary polynomial has any binary polynomial factors of degree 256 or less. A search of this magnitude is impractically time-consuming.

An improved method for constructing arbitrarily large finite fields is as shown in a Field Construction flowchart of FIG. 2. To generate a sequence a finite fields, refer to the flow chart, beginning with step 400.

In step 401, various initializations occur. The index i in G₁ is initialized to zero, the variable symbits is initialized to km, and an initial product Π₀ is initialized to 1. The fields constructed here are extension fields of a field F, represented as a canonical GF(2^{m}), with m an integer greater than zero. An extension field of F is selected as an initial “search” field G₀. Typically, a relatively small field, such as GF(16), is selected as the search field. The field G₀ may be the same as F, or may be constructed as an extension field of F by any known method, such as by selecting an irreducible polynomial of degree k over F to generate G₀. The number of bits used to represent an element in the field G₀ is km, where k is an integer greater than zero. Thereafter, each successive field in the sequence of finite fields doubles the symbol size.

The only search in the field construction method occurs once in step 402. The field G₀ is searched to find a set of elements S. An element s of G₀ becomes a member of S if and only if the polynomial

r(x)=x²+s(x+1)

is irreducible over G₀. The results of example searches are shown below.

A sequence of extension fields is then constructed from G₀, each successor subfield constructed using an irreducible polynomial of degree two, rᵢ(x), over the predecessor subfield. Determination of a successor field begins in step 403. In step 403, a particular preferred irreducible polynomial is selected by choosing a particular value sᵢ in S. The coefficients of the preferred irreducible polynomial have a deterministic product term and a scaling by the chosen member of S. Preferred polynomials help to minimize multiplier complexity by having only one non-zero search field component. The constructed finite fields may incorporate other preferred characteristics, such as being generated solely from primitive polynomials. If so, the choice of a particular value s₁ may depend in whole or in part on the desired characteristics. For example, if only primitive polynomials are desired, each potential polynomial rᵢ(x) corresponding to a choice for sᵢ in S may be tested to check if it is a primitive polynomial.

When a suitable irreducible polynomial has been selected, successor field construction is completed in step 404. The variable ωᵢ is an assumed root of the selected polynomial rᵢ(x). An element C of Gᵢ₊₁ is represented as a two-component vector

C=[c₀,c₁]

where c₀ and c₁ are elements of G₁. The element C is associated with the polynomial

C(ω₁)=c₀+c₁ωᵢ.

Also in step 404, the running product

Πᵢ₊₁=ωᵢΠᵢ

is updated, the constructed field index i is incremented, and the variable symbits is doubled.

Step 405 checks if the most recent successor field is sufficiently large for the purposes at hand. For example, the largest field generated may be used for error correction coding to protect data. In the case of error correction coding using Reed Solomon codes, the amount of data that may be protected by a given codeword is limited by the size of the constructed finite field, and step 405 may check to see if a sufficient amount of data can be protected.

If the constructed field is sufficiently large, the field construction method is complete and step 405 proceeds to termination of the Field Construction method in step 406. Otherwise, the method returns to step 403 to select a polynomial for a next successor field. Note that a successor polynomial is selected by choosing a value sᵢ in the previously found set S, without the need for a successive search. The flowchart loop of steps 403 to 405 continues until the constructed field present at step 405 is sufficiently large.

The method is demonstrated with various examples. In the examples, two preferred forms of search fields F are a field GF(2^{m}) represented with a canonical basis, or a field GF(2^{m}) in a split-field representation. The examples demonstrate efficient multipliers with symbol sizes up to 512 bits, some generated exclusively from primitive polynomials. The examples were all found on my low horsepower home computer, demonstrating the practicality of the improved field generation method.

B.2. Proof of the Validity of the Method

Proposition: The Polynomial

rₙ(x)=x²+γₙx+γₙ

is irreducible over G, and can therefore be used to extend field Gₙ to successor field Gₙ₊₁.

Proof: The proof proceeds by induction on n. A first field, G₀, is searched to find a subset of field elements, S, such that

p(x)=x²+sx+s

is irreducible over G₀ if and only ifs is a member of S. An arbitrary first member of S, s₀, is selected to generate an extension field G₁ using a first irreducible polynomial

p₀(x)=x²+s₀x+s₀.

Let ω₀ be a root of p₀(x). The extension field G₁ is in a split-field representation, where an arbitrary element R of G₁ is represented as a two-component vector with

R=r₁ω₀+r₀.

where r₀ and r₁ are elements of G₀. Consider a second polynomial

p₁(x)=x²+s₁ω_{O}x+s₁ω₀=x²+s₁Π₁(x+1)

where s₁ is an element of G₀. The polynomial p₁(x) is irreducible over G₁ if and only if p₁(x) has no root R in G. It may be observed that

$$\begin{matrix}{p}_{1} ( R ) = {R}^{2} + {s}_{1} {ω}_{0} ( R + 1 ) \\ = {( {r}_{1} {ω}_{0} + {r}_{0} )}^{2} + {s}_{1} {ω}_{0} ( {r}_{1} {ω}_{0} + {r}_{0} + 1 ) \\ = ( {r}_{1}^{2} + {s}_{1} {r}_{1} ) {ω}_{0}^{2} + {r}_{0}^{2} + {s}_{1} {ω}_{0} ( {r}_{0} + 1 ) \\ = ( {r}_{1}^{2} + {s}_{1} {r}_{1} ) {s}_{0} ( {ω}_{0} + 1 ) + {r}_{0}^{2} + {s}_{1} {ω}_{0} ( {r}_{0} + 1 ) \\ = \{ ( {r}_{1}^{2} + {s}_{1} {r}_{1} ) {s}_{0} + {s}_{1} ( {r}_{0} + 1 ) \} {ω}_{0} + ( {r}_{1}^{2} + {s}_{1} {r}_{1} ) {s}_{0} + {r}_{0}^{2} .\end{matrix}$$

It follows that p₁(R)=0 if and only if the two components of p₁(R) in G₀ are both zero. If the two components are zero, it follows that the sum of the components is zero, i.e.

r₀²+s₁(r₀+1)=0.

This equation cannot be satisfied in the first field G₀ if s₁ is an element of S. Therefore, with s₁ an element of S, p₁(x) has no roots and is irreducible.

By inductive hypothesis, assume that an arbitrary sequence of members of S,

{s₀,s₁, . . . ,sₙ₋₁},

has been selected as scalars to produce a sequence of irreducible polynomials

{p₀(x),p₁(x), . . . ,pₙ₋₁(x)},

where the polynomial

pₖ(x)=x²+sₖΠₖ(x+1)

is irreducible over the field Gₖ and is used to generate a split-field Gₖ₊₁.

Let ωₙ₋₁ be a root of pₙ₋₁(x). The extension field Gₙ₋₁ is in a split-field representation, where an arbitrary element R of Gₙ₋₁ is represented as a two-component vector with

R=r₁ωₙ₋₁+r₀.

where r₀ and r₁ are elements of Gₙ₋₂. Consider an n^{th} polynomial

pₙ(x)=x²+sₙΠₙ(x+1)

where sₙ is an element of G₀. The polynomial pₙ(x) is irreducible over Gₙ₋₁ if and only if pₙ(x) has no root R in Gₙ₋₁. It may be observed that

$$\begin{matrix}{p}_{n} ( R ) = {R}^{2} + {s}_{n} {\prod }_{n} ( R + 1 ) \\ = {( {r}_{1} {ω}_{n - 1} + {r}_{0} )}^{2} + {s}_{n} {\prod }_{n} ( {r}_{1} {ω}_{n - 1} + {r}_{0} + 1 ) \\ = {r}_{1}^{2} {ω}_{n - 1}^{2} + {r}_{0}^{2} + {s}_{n} {\prod }_{n - 1} {ω}_{n - 1} ( {r}_{1} {ω}_{n - 1} + {r}_{0} + 1 ) \\ = ( {r}_{1}^{2} + {s}_{n} {r}_{1} {\prod }_{n - 1} ) {ω}_{n - 1}^{2} + {r}_{0}^{2} + {s}_{n} {\prod }_{n - 1} {ω}_{n - 1} ( {r}_{0} + 1 ) \\ ( {r}_{1}^{2} + {s}_{n} {r}_{1} {\prod }_{n - 1} ) {s}_{n - 1} ( {ω}_{n - 1} + 1 ) + {r}_{0}^{2} + {s}_{n} {\prod }_{n - 1} {ω}_{n - 1} ( {r}_{0} + 1 ) \\ = \{ ( {r}_{1}^{2} + {s}_{n} {r}_{1} {\prod }_{n - 1} ) {s}_{n - 1} + {s}_{n} {\prod }_{n - 1} ( {r}_{0} + 1 ) \} {ω}_{n - 1} + \\ ( {r}_{1}^{2} + {s}_{n} {r}_{1} {\prod }_{n - 1} ) {s}_{n - 1} + {r}_{0}^{2} .\end{matrix}$$

It follows that pₙ(R)=0 if and only if the two components of pₙ(R) in Gₙ₋₂ are both zero. If both components are zero, the sum of the components is zero, i.e.

r₀²+sₙΠₙ₋₁(r₀+1)=0.

By inductive hypothesis, this equation cannot be satisfied in the field Gₙ₋₂ if sₙ is an element of S. Therefore, pₙ(x) has no roots and is irreducible.

B.3. Examples of Application of the Method

If the search field is GF(2), the set S={1}. By definition, the constants {sₙ} are all members of S, with sₙ=1 for all n. Extension fields of search field GF(2) are then constructed as shown in Table 2.

The first line in Table 2 indicates that the first extension, with n=0, uses the polynomial r₀(x)=x²+x+1 to generate G₁=GF(4) as an extension field of G₀=GF(2). Let ω₀ be a root of r₀(x). The second line indicates that the polynomial

r₁(x)=x²+10₂x+10₂

is irreducible over G₁ and is used to generate G₂=GF(16). Here, the notation 10₂ is shorthand used to indicate that γ₁, as a member of GF(4), is a two component vector,

[a₁,a₀]=[1,0]

over GF(2), with the understanding that γ₁=a₁ω₀+a₀=ω₀. The third line indicates that the polynomial

r₁(x)=x²+1000₂x+1000₂

is irreducible over G₂ and is used to generate G₃=GF(256). Here, the notation 1000₂ indicates that γ₂, as a member of GF(16), is a two component vector,

[b₁,b₀]=[10₂,00₂]

over GF(4), with the understanding that γ₂=b₁ω₁+b₀=ω₁ω_{O}.

TABLE 2
Beginning of construction of arbitrarily large fields from GF(2)

| n | m | γₙ | αₙ |
|---|---|---|---|
| 0 | 1 | 1 | |
| 1 | 2 | ω₀ = 10₂ | ω₀ = 10₂ |
| 2 | 4 | ω₀ω₁ = 1000₂ | ω₁ = 0100₂ |
| 3 | 8 | ω₀ω₁ω₂ = 10000000₂ | ω₀ω₂ = 00100000₂ |
| 4 | 16 | ω₀ω₁ω₂ω₃ = 1000000000000000₂ | ω₀ω₃ = 0000001000000000₂ |
| 5 | 32 | ω₀ . . . ω₄ | ω₀ω₄ |
| 6 | 64 | ω₀ . . . ω₅ | ω₀ω₅ |
| 7 | 128 | ω₀ . . . ω₆ | ω₀ω₆ |
| 8 | 256 | ω₀ . . . ω₇ | ω₀ω₇ |
| 9 | 512 | | ω₀ω₈ |

According to the proposition, an arbitrarily large finite field can be constructed by proceeding in a similar manner. Because each γₙ has only one nonzero component, multiplication by the coefficient γₙ is relatively easy, and scaling by the search field scalar, sₙ=1, is trivial. The schematics of FIG. 1 simplify for this example because each subfield multiplier has only one auxiliary output corresponding to the sole choice for sₙ, advantageously simplifying higher order extensions.

As discussed in the previous section, there are disadvantages for this construction over GF(2). The constructed multiplier for GF(16) with 63 gate-area units is 3% larger than a canonical multiplier for GF(16) with 61 gate-area units, and successor fields stem from the constructed GF(16) multiplier. On the other hand, successive multipliers may be made split-optimal with a minimal number of auxiliary outputs.

Another potential disadvantage of this example is that the third extension polynomial and successive polynomials are not primitive polynomials. In the fourth column of Table 2, a preferred primitive element αₙ for the field Gₙ₊₁ is listed. When ωₙ is the preferred primitive element of Gₙ₊₁, the polynomial rₙ(x) is primitive. In some applications, such as Reed Solomon coding over finite fields, a simple constant multiplier for a primitive element of the field is desired, implying a preference for primitive polynomials.

If the polynomial is not primitive, a primitive element of the field must typically be found and provided as in column 4 of Table 2. If the goal is to exclusively provide primitive polynomials at each construction stage, the choice of GF(2) as the search field is too constraining

As another example, let the search field F=GF(4), an extension field of GF(2) using the primitive polynomial p(x)=x²+x+1. Let a₀ be a root of p(x). The set S is the set of all suitable search field values for γ in GF(4), so that

r(x)=x²+γx+γ

is irreducible if and only if γ is a member of S. Lets denote each of the four members of GF(4) as a duobinary digit, {0₄=00₂, 1₄=01₂, 2₄=10₂, 3₄=11₂}. In this notation, the set

S={2₄,3₄}={α₀,α₀²}.

It turns out that either of the two choices for γ₀ provides a primitive polynomial over GF(4). In Table 3, large fields are constructed using GF(4) as the search field. Each is constructed using only primitive polynomials.

Note that, in the example of Table 3, an arbitrary member of s₀ of S may be selected as the value for γ₀. Thereafter, a preference for primitive polynomials requires that the sequence of selected scalar values alternates between the two members of S. This may be expressed as s₀=α₀^{k} where k is one or two, and sᵢ₊₁=sᵢ² for all i.

The construction can continue in this manner to produce arbitrarily large finite fields. The constructed polynomials have been verified to be primitive with symbol sizes up to 512 bits. I conjecture that the alternating selection of scalar values in this example provides primitive polynomials for all values of n.

TABLE 3
Construction of fields from GF(4) using only primitive polynomials

| n | m | γₙ | αₙ |
|---|---|---|---|
| 0 | 2 | α₀^{k} = 2₄ or 3₄ | 2₄ |
| 1 | 4 | α₀^{2k}ω₀ = 30₄ or 20₄ | ω₀ = 10₄ |
| 2 | 8 | α₀^{4k}ω₁ω₀ = 2000₄ or 3000₄ | ω₁ = 0100₄ |
| 3 | 16 | α₀^{8k}ω₂ω₁ω₀ = 30000000₄ or 20000000₄ | ω₂ = 00010000₄ |
| 4 | 32 | α₀^{16k}ω₀ . . . ω₃ | ω₃ |
| 5 | 64 | α₀^{32k}ω₀ . . . ω₄ | ω₄ |
| 6 | 128 | α₀^{64k}ω₀ . . . ω₅ | ω₅ |
| 7 | 256 | α₀^{128k}ω₀ . . . ω₆ | ω₆ |
| 8 | 512 | | ω₇ |

For more examples, let the search field F=GF(16), a canonical extension field of GF(2) using the primitive polynomial p(x)=x⁴+x+1. Let α be a root of p(x). Here, an element B of GF(16) is denoted as a 4-tuple {b₃b₂b₁b₀}₂ with the understanding that

B(α)=b₃α³+b₂α²+b₁α+b₀.

Interpreting the 4-tuple as a hexadecimal digit, the powers of α in GF(16) are given by

AntilogTable={1,2,4,8,3,6,C,B,5,A,7,E,F,D,9,1},

where the i^{th} entry of AntilogTable is αⁱ, starting with i=0. The field F is searched to find the set S, where

S={2,3,4,5,8,A,C,F}₁₆.

Note that S provides eight choices at each construction stage for s. Several low powers of α, including α=2₁₆, α²=4₁₆, and α³=8₁₆, are members of S and are available as auxiliary outputs of a modified canonical GF(16) multiplier.

One method of constructing arbitrarily large fields is to select members of S to provide a minimal complexity constant multiplication at each construction stage.

For example, one sequence of selections that simplifies implementation is to use a single constant as in Example 1 above, but with a sole value such as sᵢ=α for all i in this example for the search field GF(16). A disadvantage of this sequence is that the second extension field, GF(65536), and subsequent extension fields use polynomials that are not primitive.

In Table 4, two preferred sequences of selections are listed to provide examples with primitive polynomials at all construction stages. The first sequence of selections is listed as column sₙ in Table 4, whereas an alternative second sequence of selections is listed as column tₙ. The sequences were found using a computer program implementing the flowchart of FIG. 2, using a preference for primitive polynomials where each sᵢ is a low power of α. Multipliers to implement the extension fields from this example are the least complex known for common computer symbol sizes in multiples of eight bits.

TABLE 4
Construction of fields from canonical GF(16)
using only primitive polynomials

| n | m | sₙ | tₙ | αₙ |
|---|---|---|---|---|
| 0 | 4 | 4₁₆ | 2₁₆ | 2₁₆ |
| 1 | 8 | 2₁₆ | 8₁₆ | ω₀ = 10₁₆ |
| 2 | 16 | 4₁₆ | 4₁₆ | ω₁ = 0100₁₆ |
| 3 | 32 | 8₁₆ | 8₁₆ | ω₂ = 00010000₁₆ |
| 4 | 64 | 2₁₆ | 4₁₆ | ω₃ |
| 5 | 128 | 8₁₆ | 2₁₆ | ω₄ |
| 6 | 256 | 4₁₆ | 4₁₆ | ω₅ |
| 7 | 512 | | | ω₆ |

B.4. The Improved Construction Method with Prior Art Polynomials

As discussed in the introduction A.1, a prior art split-field construction method may be used to extend a finite field F to a field G using a quadratic irreducible polynomial of the form

q(x)=x²+x+β.

A prior art finite field multiplier for the extension field G may be implemented using three full multipliers for the field F, four adders for the field F, and a constant multiplier, multiplying by the constant I. Given a plurality of possible choices for β, a polynomial q(x) that facilitates simple constant multiplication is preferably selected. To minimize complexity, the field F is typically searched for all suitable values for β, and a polynomial q₀(x) with a particular value β₀ that minimizes complexity is selected.

It is known in the art that this extension method may be applied repeatedly. If an extension field H doubling the symbol size of G is desired, the field G is searched for a new set of suitable values for β, and a polynomial q₁(x) with a particular value β₁ that minimizes complexity is selected. A disadvantage of this approach is that it requires a new search at each stage of construction.

Instead, a method of selecting a sequence of irreducible polynomials for extending the field G without additional searches, as in the previous section, is desired. The flowchart of FIG. 2 may be modified to support the prior art's preferred quadratic polynomial as follows. Steps 400, 401, 402, 405, and 406 remain as shown in FIG. 2.

Step 403 is replaced by a new step 503 (not shown in FIG. 2). The new step 503 is as follows:

Step 503:

Select a scalar sᵢ in S.

Let rᵢ(x)=x²+x+Πᵢ/sᵢ

Note that step 503 defines polynomial rᵢ(x) differently than in step 403.

Step 404 is replaced by a new step 504 (not shown in FIG. 2). The new step 504 is as follows:

Step 504:

Let ωᵢ be a root of rᵢ(x).

Construct field Gᵢ₊₁ as a split-field using a {1, ωᵢ} basis and rᵢ(x).

Let Πᵢ₊₁=(ωᵢ+1) Πᵢ.

Increment i and double symbits.

Note that step 504 also redefines the running product R.

As a simple example, suppose that a multiplier for GF(65536) is to be constructed using the improved method with prior art polynomials over F=GF(16). The field F is in a canonical representation and is generated by the primitive binary polynomial,

p(x)=x⁴+x+1,

as above. Let α be a root of p(x). The field F is searched to find the set S, where

S={α,α²,α³,α⁴,α⁶,α⁸,α⁹,α¹²}={2,4,8,3,C,5,A,F}₁₆.

A first selection from S, s₀=α²=4₁₆, is used to form a primitive quadratic polynomial over F,

q₀(x)=x²+x+s₀⁻¹=x²+x+α¹³=x²+x+D₁₆.

A binary vector

{b₃,b₂,b₁,b₀}₂

representing a symbol in a canonical GF(16) may be multiplied by the choice β_{O}=D₁₆ using two XOR gates and a rearrangement to obtain

{b₀+b₁,b₀,b₃,b₀+b₁+b₂}₂.

A multiplier for GF(256) using this selection is implemented using three GF(16) multipliers, four GF(16) adders, and a β-multiplier, with a total of 48 AND gates and 63 XOR gates. Let ω₀ be a root of q₀(x). A second selection from S, S₁=α, is used to form a primitive quadratic polynomial over GF(256),

q₀(x)=x²+x+α¹⁴(ω₀+1).

Multiplication by the choice β₁=α¹⁴(ω₀+1) in the sixteen-bit multiplier may be performed in two steps. Given that an eight-bit multiplier contains a constant multiplier providing α¹³b₁, a split-field vector

B=b₁ω₀+b₀

may be multiplied by (ω₀+1) to form

(ω₀+1)B=b₀ω₀+(b₀+α¹³b₁),

using four XOR gates, and each of two components of this sub-product may be scaled by α¹⁴ using a single XOR gate. These six XOR gates may be added to one of three eight-bit multipliers in a sixteen-bit multiplier to provide an auxiliary output multiplying one eight-bit input by β₁. The total number of gates for a sixteen bit multiplier using these selections and resource sharing through an auxiliary output is 144 AND gates and 227 XOR gates, or 825 gate-area units. The doubly split-optimal multipliers for GF(65536) disclosed in the previous section are more efficient, using 144 AND gates and 215 XOR gates, or 789 gate-area units.

By way of comparison, a prior art best example multiplier for GF(65536) is listed in Table 1 and shown in FIG. 1 of Paar, supra, p. 860. The prior art sixteen-bit multiplier uses 144 AND gates and 258 XOR gates, or 918 gate-area units. It is about 11% larger than the example above, and about 16% larger than the optimal multiplier for GF(65536).

A second advantage of the method disclosed here is that it allows for scalable implementations in software. Suppose, for example, that the sixteen-bit multiplier described in this section is to be implemented in software using known techniques for multiplication involving log and antilog tables. With the new construction, a software implementer may elect to use one of the three following alternatives. The first alternative allocates a storage space of 32 four-bit entries for log and antilog tables over GF(16), providing that a GF(65536) multiplication may be accomplished using 27 GF(16) log table lookups and relatively simple operations. The second alternative allocates a storage space of 512 eight-bit entries for log and antilog tables over GF(256), so that a GF(65536) multiplication may be accomplished using nine GF(256) log table lookups and simple operations. This second alternative provides a good compromise between throughput performance and storage requirements. The third alternative uses a storage space of 131,072 sixteen-bit entries for log and antilog tables for GF(65536), providing that a GF(65536) multiplication may be accomplished using three log table lookups and simple operations. Throughput may be flexibly traded off against required storage space to accommodate various needs. With the prior art construction, a best multiplier for GF(65536) is constructed directly as an extension field of GF(16), without the same alternative of supporting operations implemented over GF(256) with intermediate sized tables.

A further advantage of the improved construction method is that it provides for construction of a plurality of successor fields without requiring additional searches, using a preferred form of the constant βᵢ for each successor field. If extension polynomials using the form of q(x) are preferred, the modified construction method can be used to produce arbitrarily large fields using this preferred form without consuming the additional time and resources of additional polynomial searches.

The embodiments shown and discussed here are for purposes of illumination and are not for purposes of limitation. As is well known in the art, various features of the methods discussed here may be implemented in other equivalent ways, and other combinations and permutations of the methods discussed herein may be utilized without departing from the true spirit of the invention, which is limited only by the claims.

1. A method of multiplying a first 2m-bit symbol and a second 2m-bit symbol of a field G, the method comprising
partitioning the first 2m-bit symbol of the field G into two m-bit component symbols, a₀ and a₁, of an m-bit symbol subfield F;
partitioning the second 2m-bit symbol of the field G into two m-bit component symbols, b₀ and b₁, of the subfield F;
determining a product m₁ equal to the product of a₀ and b₁ in the subfield F;
determining a sum t₀ equal to the sum of b₀ and a symbol gamma b₁ in the subfield F;
determining a product m₂ equal to the product of a₀ and the sum t₀ in the subfield F;
determining a sum t₁ equal to the sum of a₁ and a₀ in the subfield F;
determining a product m₃ equal to the product of b₀ and the sum t₁ in the subfield F;
determining a symbol c₀ equal to the sum of the product m₃ and the product m₂ in the subfield F;
determining a symbol C₁ equal to the sum of the product m₁ and the product m₂ in the subfield F; and
combining the symbol c₀ and the symbol C₁ into a 2m-bit symbol of the field G equal to the product of the first 2m-bit symbol and the second 2m-bit symbol;
wherein the polynomial r(x)=x²+gamma (x+1) is an irreducible polynomial over F used to define G and wherein gamma is not the multiplicative identity of F.

2. The method of claim 1, wherein gamma is equal to a low power of a primitive element alpha of the subfield F.

3. The method of claim 1, wherein the symbol gamma b₁ is provided by an auxiliary determination in a product determination in the subfield F.

4. The method of claim 1, wherein the symbol gamma b₁ is determined using log and antilog tables in a subfield of G.

5. The method of claim 1, wherein gamma is equal to the product of a deterministic product Π of quadratic polynomial roots and an arbitrary member s of a subset S of elements of a subfield of G.

6. The method of claim 1, wherein gamma is represented as two (m/2)-bit component symbols, g₀ and g₁, of a subfield of the subfield F, wherein g₀ is equal to zero.

7. An apparatus for multiplying a first and a second 2m-bit symbol of an extension field G, the apparatus operative to
partition the first 2m-bit symbol of the field G into two m-bit component symbols, a₀ and a₁, of an m-bit symbol subfield F;
partition the second 2m-bit symbol of the field G into two m-bit component symbols, b₀ and b₁, of the subfield F;
multiply a₀ and b₁ in the subfield F to determine a product m₁;
add b₀ and a symbol gamma b₁ in the subfield F to determine a sum t₀;
multiply a₀ and the sum t₀ in the subfield F to determine a product m₂;
add a₁ and a₀ in the subfield F to determine a sum t₁;
multiply b₀ and the sum t₁ in the subfield F to determine a product m₃;
add the product m₃ and the product m₂ in the subfield F to determine a symbol c₀;
add the product m₁ and the product m₂ in the subfield F determine a symbol c₁; and
combine the symbol c₀ and the symbol c₁ into a 2m-bit symbol of the field G equal to the product of the first 2m-bit symbol and the second 2m-bit symbol;
wherein the polynomial r(x)=x²+gamma (x+1) is an irreducible polynomial over the subfield F used to define the field G and wherein gamma is not the multiplicative identity of the subfield F.

8. The apparatus of claim 7, wherein gamma is equal to a low power of a primitive element alpha of the subfield F.

9. The apparatus of claim 7, wherein the symbol gamma b₁ is provided by an auxiliary output of a multiplier for the subfield F.

10. The apparatus of claim 7, wherein the symbol gamma b₁ is determined using log and antilog tables in a subfield of G.

11. The apparatus of claim 7, wherein gamma is equal to the product of a predetermined product Π of quadratic polynomial roots and an arbitrary member s of a subset S of elements of a subfield of G.

12. The apparatus of claim 7, wherein gamma is represented as two (m/2)-bit component symbols, g₀ and g₁, of a subfield of the subfield F, wherein g₀ is equal to zero.

13. A method to construct an extension field G[n] of a sufficient size for a particular purpose, the method comprising
a step to initialize an index i=0, to select an initial field G[0] of characteristic two to be searched and extended, and to initialize a deterministic product term Π[0] equal to a multiplicative identity;
a step to search the initial field G[0] to determine a set S of scalars from the initial field G[0];
a step to select a member s[i] of S to construct an extension field G[i+1] of a finite field to be extended G[i] using an irreducible quadratic polynomial d[i] determined from the selected member s[i] of 5; and
a step to check the size of the constructed extension field G[i+1] and return to the previous step until an extension field G[n] of sufficient size has been constructed, said return to the previous step using the constructed extension field G[i+1] as the next field to be extended and incrementing the index i;
wherein a coefficient of the irreducible quadratic polynomial d[i] determined from the selected member s[i] of S is a deterministic product term Π[i] scaled by the selected member s[i] of S; and
wherein said coefficient of the irreducible quadratic polynomial is not the multiplicative identity of the field to be extended G[i].

14. The method of claim 13, wherein the irreducible quadratic polynomial d[i] is a polynomial of the form
r[i](x)=x²+(x+1)s[i]Π[i],
wherein said deterministic product term Π[i] is equal to the product ω[i−1] Π[i−1] when the index i is greater than zero, and wherein said ω[i−1] is a root of the polynomial r[i−1](x).

15. The method of claim 13, wherein the irreducible quadratic polynomial r[i] is a polynomial of the form
r[i](x)=x²+x+Π[i]/s[i],
wherein said deterministic product term Π[i] is equal to the product (1+ω[i−1]) Π[i−1] when the index i is greater than zero, and wherein said ω[i−1] is a root of the polynomial r[i−1](x).

16. The method of claim 13, wherein the step to select a member s[i] of S and construct an extension field G[i+1] of a field to be extended G[i] uses a primitive quadratic polynomial r[i] determined from the selected member s[i] of S.

17. The method of claim 13, wherein the step to search the initial field G[0] to determine a set S of scalars from the initial field G[0] includes a scalar s from the initial field G[0] in the set S if and only if the polynomial
r(x)=x²+(x+1)s,
is an irreducible polynomial over the initial field G[0].
